(19) United States
(12) Patent Application Publication
(10) Pub. No.: US 2005/0086095 A1
(43) Pub. Date: Apr. 21, 2005

(54) Method and system for improving company's sales

(75) Inventor: Rodney L. Moll, San Diego, CA (US)

Correspondence Address: PROCOPIO, CORY, HARGREAVES & SAVITCH LLP, 530 B STREET, SUITE 2100, SAN DIEGO, CA, 92101, US

(73) Assignee: Moll Consulting, Inc.

(21) Appl. No.: 10/688,450

(22) Filed: Oct. 17, 2003

(51) Int. Cl. G06F 17/60

(52) U.S. Cl. 705/10

(57) ABSTRACT

A method for improving sales of a company includes performing mystery shopping at a company; evaluating the mystery shopping; transmitting evaluation data for the mystery shopping to a central location; determining a relevant improvement factor for the company at the central location based on analysis of the evaluation data for the mystery shopping; developing a specific knowledge product for improving employees of the company in the relevant improvement factor; and implementing the specific knowledge product with the employees of the company for improving the employees of the company in the relevant improvement factor, increasing customer satisfaction and sales. Specific training for improving employees in the relevant improvement factor may be developed and implemented with the specific knowledge product.

### FIELD OF THE INVENTION

The present invention is in the field of methods and systems for improving sales of a company.

### BACKGROUND OF THE INVENTION

Measuring customer satisfaction levels is critical to a company's success. One of the biggest challenges facing the service industry is taking great care of the customer on a consistent basis. An indifferent, perfunctory, or rude service encounter can erode a customer's confidence in an establishment and cost a company future business. Even worse, poor service may occur on a regular basis and a company may never hear about it to correct it. A weak economy, downsizing, and the elimination of many mid-level management positions has made it more difficult to effectively train and monitor personnel. When management measures service and employee performance on a regular basis, weaknesses can quickly be identified, saving a company hundreds of thousands of dollars in lost revenues and payroll costs. Mystery shopper programs have been used in the past in an effort to secretly measure performance and provide information to a company to improve guest satisfaction. A problem with mystery shopper programs is that they either do not offer training and education to improve service and employee performance or they do not effectively implement training and education with long-lasting benefit to improve service and employee performance over a long period of time. As a result, even if weaknesses in service and employee performance are identified through mystery shopping, the weaknesses may not be effectively addressed.

### SUMMARY OF THE INVENTION

The present invention involves a targeted method for improving sales of a company and includes the steps of 1) performing mystery shopping at a company location; 2) evaluating the mystery shopping experience at the company location, 3) determining a relevant improvement factor based on the evaluation of the mystery shopping experience, 4) developing a specific knowledge product and specific training for improving the company in the area of the relevant improvement factor, and 5) implementing the specific knowledge product and specific training for improving the company in the area of the relevant improvement factor. The above method may be provided for a company on a money-back guarantee basis so that if the company does not improve its performance in the area of the relevant improvement factor (or improve another measurable aspect, e.g., increase in sales), the consideration (or a portion of the consideration) provided for the performance of the above method would be returned. The above method or various steps of the above method may be performed multiple times with the same company to improve multiple improvement factors. The above method may be performed in other sectors, such as, but not limited to, the public sector, instead of the private sector, to improve performance of public servants in one or more relevant improvement factors.

Another aspect of the invention includes a method for improving sales of a company. The method includes 1) performing mystery shopping at a company; 2) evaluating the mystery shopping; 3) transmitting evaluation data for the mystery hopping to a central location; 4) determining a relevant improvement factor for the company at the central location based on analysis of the evaluation data for the mystery shopping; 5) developing a specific knowledge product for improving employees of the company in the relevant improvement factor; and 6) implementing the specific knowledge product with the employees of the company for improving the employees of the company in the relevant improvement factor, increasing customer satisfaction and sales. In a preferred implementation of the above aspect of the invention, the method may also include developing a specific training program for improving employees of the company in the relevant improvement factor; and implementing with the specific knowledge product the specific training program with the employees of the company for improving the employees of the company in the relevant improvement factor, increasing customer satisfaction and sales.

A further aspect of the invention involves a method for improving service of an service entity. The method includes 1) performing mystery evaluation at a service entity location; 2) evaluating the mystery evaluation; 3) transmitting evaluation data for the mystery evaluation to a central location; 4) determining a relevant improvement factor for the service entity at the central location based on analysis of the evaluation data for the mystery evaluation; 5) developing a specific knowledge product for improving members of the service entity in the relevant improvement factor; and 6) implementing the specific knowledge product with the members of the service entity for improving the members of the service entity in the relevant improvement factor, improving service. In a preferred implementation of the above aspect of the invention, the method may also include developing a specific training program for improving members of the service entity in the relevant improvement factor; and implementing with the specific knowledge product the specific training program with the members of the service entity for improving members of the service entity in the relevant improvement factor, improving service.

A still further aspect of the invention involves a method for improving sales of a company. The method includes 1) determining a relevant improvement factor for employees of the company at a central location based on analysis of customer shopping data; 2) developing a specific knowledge product and a specific training program for improving employees of the company in the relevant improvement factor; and 3) implementing the specific knowledge product and the specific training program with the employees of the company for improving the employees of the company in the relevant improvement factor, increasing customer satisfaction and sales.

Further objects and advantages will be apparent to those skilled in the art after a review of the drawings and the detailed description of the preferred embodiments set forth below.

### BRIEF DESCRIPTION OF THE DRAWINGS

FIG. 1 is a flow chart of an exemplary process for improving sales of a company.

FIG. 2 is a top plan view of an embodiment of a knowledge product.

FIG. 3 is a flow chart of an alternative process for improving sales of a company.

FIG. 4A is a block diagram illustrating an embodiment of a system for improving sales of a company.

FIG. 4B is a block diagram illustrating an embodiment of an analysis server of the system of FIG. 4A.

FIG. 5 is a block diagram illustrating an exemplary computer system as may be used in connection with various embodiments described herein.

### DETAILED DESCRIPTION OF PREFERRED EMBODIMENTS

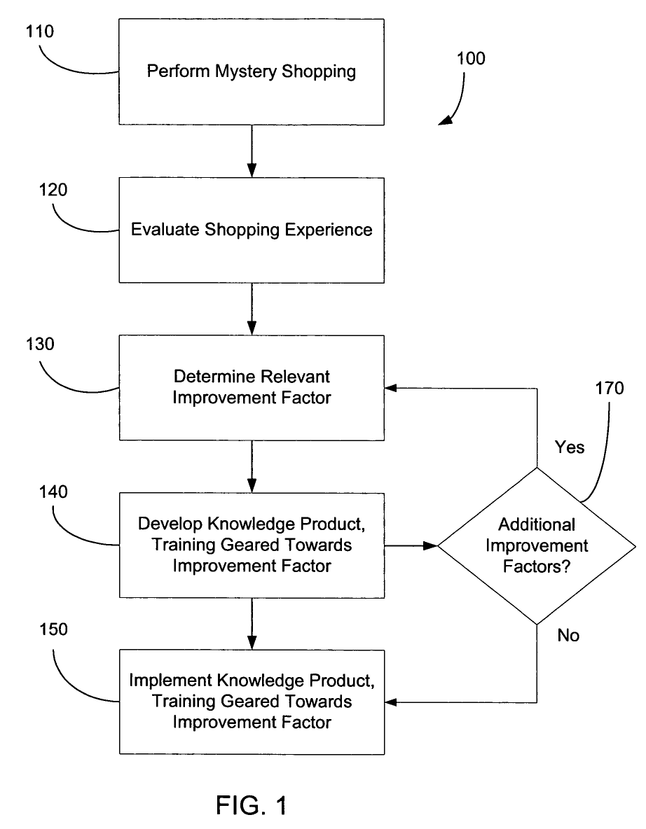

With reference to FIG. 1, an exemplary method 100 for improving sales of a company in the hospitality industry will now be described. The method 100 will be described in conjunction with improving an improvement factor related to service and employee performance. Improvement in this improvement factor improves service and employee performance, resulting in an improvement in guest satisfaction and an increase in sales for the company. Although the method 100 will be described in conjunction with improving an improvement factor related to service and employee performance in the hospitality industry, the method may be used for improving an improvement factor for improving service and employee performance in other commercial industries or for improving an improvement factor of individuals in other sectors. For example, but not by way of limitation, the method 100 may be used for improving an improvement factor of public servants in the public sector and/or for improving an improvement factor of other individuals.

In an exemplary embodiment, the method 100 includes the steps of 1) performing mystery shopping at a company location 110; 2) evaluating the mystery shopping experience 120, 3) determining a relevant improvement factor based on the evaluation of the mystery shopping experience 130, 4) developing a specific knowledge product and/or specific training for improving employees of the company in the area of the relevant improvement factor 140, and 5) implementing the specific knowledge product and/or specific training with the employees of the company for improving the company in the area of the relevant improvement factor 150. Each of these steps of the exemplary method 100 will be described in turn below:

1. Mystery Shopping:

Performing mystery shopping 110 involves an unknown (“mystery”) shopper visiting a store location of the company to shop or conduct business at the store location. The mystery shopper may be an employee of a mystery shopping company or may be an independent contractor performing the mystery shopping on behalf of an entity at a central location. In the exemplary method described herein, the company is a fictitious company called Mega Burger Restaurants (“MBR”) and the store location is one of the MBR restaurants, which, for example, may be owned by MBR or may be independently owned by a franchisee of MBR. Although a single mystery shopper has been described as mystery shopping at a single store location of a company, in alternative embodiments, multiple different mystery shoppers may mystery shop at multiple respective store locations. Also, the same mystery shopper or different mystery shoppers may mystery shop more than once at a store location.

During mystery shopping, the mystery shopper engages in a shopping experience and transaction with one or more employees of the store location without the one or more employees of the store location knowing that the mystery shopper has been hired to evaluate the shopping experience. In the MBR example, the mystery shopper may visit a MBR restaurant, wait in line at the MBR restaurant, order a hamburger from a cashier, pay for the hamburger, and receive the hamburger from the cashier or another employee of the restaurant. The shopping experience may also include, but not by way of limitation, obtaining eating utensils and condiments; obtaining a soda from a soda fountain; dining in at the restaurant, and using the restroom facilities. The employee(s) of the restaurant servicing the mystery shopper are not aware that the mystery shopper was hired to engage in the mystery shopping. As a result, the mystery shopping experience is an objective, untainted shopping experience that is helpful for obtaining object performance data on employees and service at the store location.

2. Evaluating Shopping Experience:

At step 120, the mystery shopper evaluates the mystery shopping experience by preferably answering a number of predetermined questions provided by the entity at the central location. The questions are related to the shopping experience and are immediately answered after the mystery shopping experience. In an alternative embodiment, the questions related to the shopping experience are answered during the mystery shopping experience (e.g., answers entered into a PDA or other handheld device while eating). Answers to the mystery shopping questions are transmitted from the mystery shopper to a central location. Other relevant information such as, but not limited to, information on the store location (e.g., store number, store address) may be transmitted to the central location. Input of the answers to the mystery shopping questions and transmittal of the answers to the central location may occur in numerous different ways.

For example, but not by way of limitation, the answers to the mystery shopping questions may be written down on a form by the mystery shopper, input into a computer, and then transmitted from the mystery shopper's computer via a network such as the Internet to a server at the central location. The entity at the central location may have a web site on a server that is accessible via the Internet from the mystery shopper's computer. The web site may require mystery shoppers to log on. Once logged on, the mystery shopper may enter answers to the mystery shopping questions via the web site. Data representative of the answers may be stored in storage on the same or a different server from the server that the web site is on.

Alternatively, the answers and other information related to the mystery shopping experience may be input into a laptop, palm top, personal digital assistant (“PDA”), Internet phone, or other communication device. The device may be linked to a computer for downloading the data to the computer. The data may then be transmitted from the computer via a network such as the Internet to one or more servers at the central location. Alternatively, the laptop, palm top, PDA, Internet phone, or other communication device may be used by the mystery shopper to wirelessly transmit the data to the one or more servers at the central location. Further, the answers and other information related to the mystery shopping experience may be mailed, faxed, or otherwise transmitted to the central location. Still further, an interactive electronic form controlled by the central location may be provided (e.g., on a PDA or other handheld device) and the interactive electronic form may guide the mystery shopper through the evaluation process.

Multiple mystery shoppers may mystery shop different respective store locations of a company, a mystery shopper may mystery shop more than one store location, and/or more than one mystery shopper may mystery shop at a single store location. Regardless, each mystery shopper evaluates the mystery shopping experience by preferably answering a number of predetermined questions related to the shopping experience during or immediately after the mystery shopping experience, and the answers to the mystery shopping questions and other relevant information are transmitted from the mystery shopper to the entity at the central location, and preferably to one or more servers at the central location.

3. Determining Relevant Improvement Factors:

The step 130 of determining the relevant improvement factors is preferably performed at the central location, and may be performed by the same or a different server from that which the web site is on and receives the data representative of the answers to the mystery shopping questions. Step 130 includes determining the most relevant factor(s) where the company or one or more store locations of the company need improvement. This step may be performed by statistical analysis software on the one or more servers or another computer. The evaluation data from the mystery shopping may be analyzed to determine what improvement factor(s) of customer service a store location or multiple store locations fall shortest in customer expectation with the mystery shopper(s). For example, in the MBR example, it may be determined from the evaluation data from the mystery shopper for a store location or multiple store locations that “responsiveness” is an area or relevant improvement factor where the employees of the store location(s) score the lowest and need the greatest amount of improvement. Analysis of the evaluation data may indicate that the employees of the store location(s) score low in multiple areas or relevant improvement factors. Thus, it may be determined that more than one improvement factor exists where the employees need improvement. As used herein, a “relevant improvement factor” means an area or improvement factor that, if improved, will improve customer satisfaction and improve sales of the company.

4. Developing Specific Knowledge Product and/or Training Geared Towards Improvement Factor:

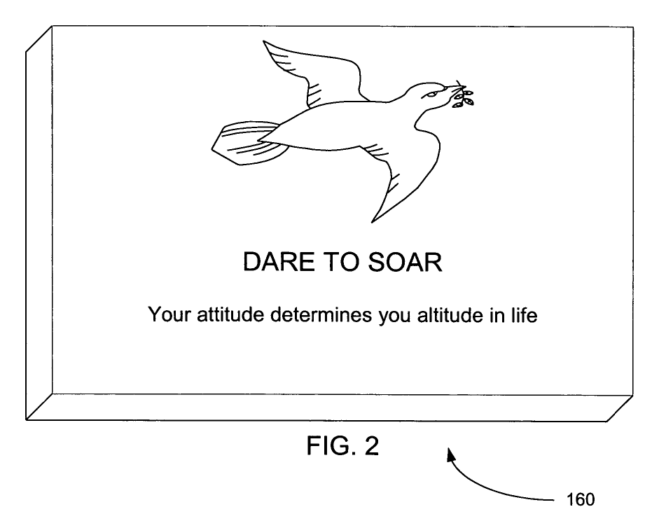

The next step 140, developing a specific knowledge product and/or specific training for improving the company in the area of the relevant improvement factor, may be performed at the central location or one or more additional locations. FIG. 2 illustrates an embodiment of a knowledge and motivational product (hereinafter “knowledge product”) 160. The knowledge product 160 shown is a mouse pad with an image of a bird flying with the words “DARE TO SOAR—Your attitude determines your altitude in life.” The specific knowledge product 160 show in FIG. 2 is for illustrative purposes only to assist the reader with an understanding of what a knowledge product 160 may be and is not geared towards improving the improving factor of “responsiveness.” Although a specific type of knowledge product 160 is shown in FIG. 2, this type of knowledge product is an example of one of numerous different types of knowledge products 160 and should in no way be considered to limit the scope or interpretation of what a knowledge product 160 may entail.

A knowledge product 160 is a concrete, tangible, physical product that, especially when used in conjunction with a training program or story, creates a fundamental shift in how the user views things (i.e., creates a revelation or paradigm shift in the user's thinking). The knowledge product 160 is observed or sensed using at least one of the five basic senses. In a more preferred embodiment, the knowledge product 160 is sensed using at least two of the five basic senses. In a most preferred embodiment, the knowledge product 160 is sensed using at least three of the five basic senses. Sensing the knowledge product 160 using more than one of the five basic senses helps to reinforce the theme of the knowledge product and create this paradigm shift in the thinking of the employee or individual targeted to receive the knowledge product 160. The knowledge product 160 is specifically designed for and relates to (i.e., targeted for) improving the improvement factor determined in step 130.

Additionally, specific training and education (hereinafter “training”) preferably utilizing the knowledge product 160 is specifically developed for improving the improvement factor (e.g., responsiveness) determined in step 130 at the central location. The training is preferably live or remote. However, the training may be, but not by limitation, pre-recorded, computer-implemented, and Internet-implemented.

The training focuses on improving the employees of the company in the improvement factor where the company's employees need improvement (e.g., responsiveness). Training may be independent or in combination with the knowledge product 160.

In combination, both the knowledge product 160 and the training utilizing the knowledge product 160 are designed to create the paradigm shift in thinking, “bring the message home,” and have a lasting impression on the improvement factor where the company's employees need improvement to cause improvement in this factor, resulting in improved customer satisfaction and improved sales.

Separately, the knowledge product 160 and training are also preferably designed to create the paradigm shift in thinking, “bring the message home,” and have a lasting impression on the improvement factor where the company's employees need improvement to cause improvement in this factor, resulting in improved customer satisfaction and improved sales, although generally less effectively than in combination.

Because analysis of the evaluation data in step 130 may indicate that the employees of the store location(s) score low in multiple areas or relevant improvement factors, multiple different specific types of knowledge products and specific training and combinations thereof may be developed for improving the various improvement factors of the company needing improvement.

5. Implementing the Specific Knowledge Product and/or Training:

In step 150, the knowledge product 160 and training specific to the improvement factor determined in step 130 are provided to the employees of the company needing improvement of the improvement factor. The knowledge product 160 is given to each employee (or in alternative embodiments, is given to a group of employees) to keep. After the training, the knowledge product 160 is preferably provided in a location where the employee(s) sense the knowledge product 160 with at least one of the five senses on a frequent basis. The specific knowledge product 160 and the training utilizing the knowledge product create a paradigm shift in thinking, “bring the message home,” and have a lasting impression on the improvement factor where the company's employees need improvement to cause improvement in this factor, resulting in improved customer satisfaction and improved sales. Utilizing a knowledge product 160 that is sensed using more than one of the five basic senses, and especially a knowledge product 160 utilizing three or more of the five basic senses, helps to reinforce the theme of the knowledge product 160 and make that theme last with the employees. The greater the number of senses that an employee may use to sense the knowledge product, the more the theme of the specific knowledge product 160 and training will last with the employee.

Most training done in the past has been very passive. Students listen to a teacher and participate some minimal amount. The benefit of the training is generally not long-lasting. By utilizing specific training for improving the employees in the area of the improvement factor, tying the training with the specific knowledge product 160 for the improvement factor, giving each employee the physical, concrete, tangible knowledge product 160 that is part of the training and may be sensed with more than one of the five basic senses (and preferably at least three of the five basic senses), and providing the knowledge product 160 in a location where the employee will sense the knowledge product 160 frequently, the theme of the knowledge product and the training will last with the employee, causing improvement in the improvement factor. After the training, every time the employee senses the knowledge product 160 with at least one of the five senses, the theme of the training is reinforced with the employee. This helps ensure that the employee continues to perform well in the area of the improvement factor, resulting in an increase in customer satisfaction and increase in sales.

Implementation of the method 100 for improving sales of a company is preferably performed by or on behalf of a single entity at the central location. In another embodiment of the invention, the method 100 is performed for a company on a money-back guarantee basis so that if the company does not improve its performance in the area of the relevant improvement factor (or improve another measurable aspect, e.g., increase in sales by X %), the consideration (or a portion of the consideration) provided for the performance of the above method 100 is returned to the company.

In another embodiment, the method 100 or one or more of the steps 110, 120, 130, 140, 150 of the method 100 may be performed multiple times with the same company to improve multiple improvement factors (e.g., responsiveness, politeness, cleanliness). For example, the mystery shopping step 100, evaluation of shopping experience step 120, and determination of relevant improvement factors step 130 may reveal more than one relevant improvement factor for a company. Accordingly, as shown in FIG. 1, the developing of specific knowledge product and/or training step 140 and the implementing of specific knowledge product and/or training step 150 may be repeated if it is determined at step 170 that additional relevant improvement factors exist. Further, the implementation of the specific knowledge product and/or training step 150 may occur as many times and as many locations as are necessary to train all the requisite employees of the company.

In a further embodiment, the above method 100 may be performed in the public sector, instead of the private sector, to improve performance of public servants in one or more relevant improvement factors. For example, but not by way of limitation, the method 100 may performed for elected officials and/or for employees of city government, state government, and/or federal government. The above method 100 may be performed for non-profit, charitable, volunteer, and/or religious organizations. In a still further embodiment, the above method 100 may be performed in the public generally to improve performance of individuals in one or more relevant improvement factors.

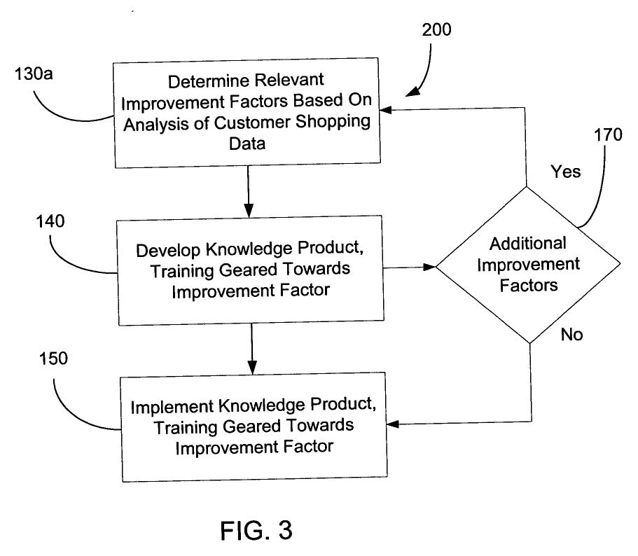

In alternative embodiments, the method 100 may include more steps, less steps, or different steps than those indicated above. For example, but not by way of limitation, instead of obtaining customer satisfaction data from the mystery shopping step 110 and evaluating shopping experience step 120, the customer satisfaction data may come from real customers. This data may come from customer questionnaires, interviews, or the like. The data may come from marketing data or other data sources other than through mystery shopping. FIG. 3 is a flow chart of an exemplary method 200 similar to the method 100 described above with respect to FIGS. 1 and 2, except steps 110 and 120 in FIG. 1 are not shown and step 130 is replaced with step 130a. Step 130a includes determining a relevant improvement factor for employees of the company at a central location based on analysis of customer shopping data. Thus, at step 130a, regardless of the customer shopping data source (e.g., mystery shopping and evaluation, customer questionnaires, customer interviews, marketing data), the relevant improvement factors are determined based on analysis of customer shopping data. At step 140, a specific knowledge product and/or training geared towards a relevant improvement factor is developed, and at step 150, the specific knowledge product and/or training geared towards the relevant improvement factor is implemented. Similar to method 100 described above, the method 200 or one or more of the steps 130a, 140, 150 of the method 200 may be performed multiple times with the same company to improve multiple improvement factors (e.g., responsiveness, politeness, cleanliness). For example, the determination of relevant improvement factor based on analysis of customer shopping data step 130a may reveal more than one relevant improvement factor for a company. Accordingly, as shown in FIG. 3, the developing of specific knowledge product and/or training step 140 and the implementing of specific knowledge product and/or training step 150 may be repeated if it is determined at step 170 that additional relevant improvement factors exist.

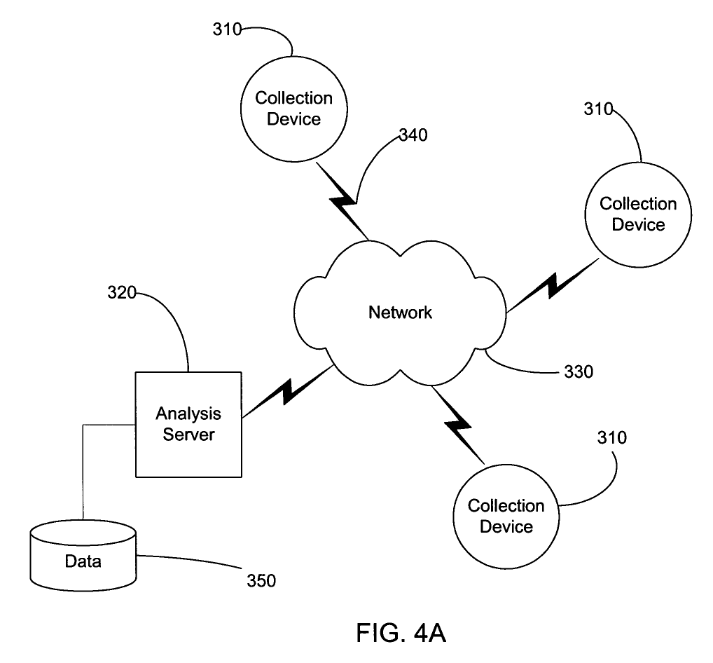

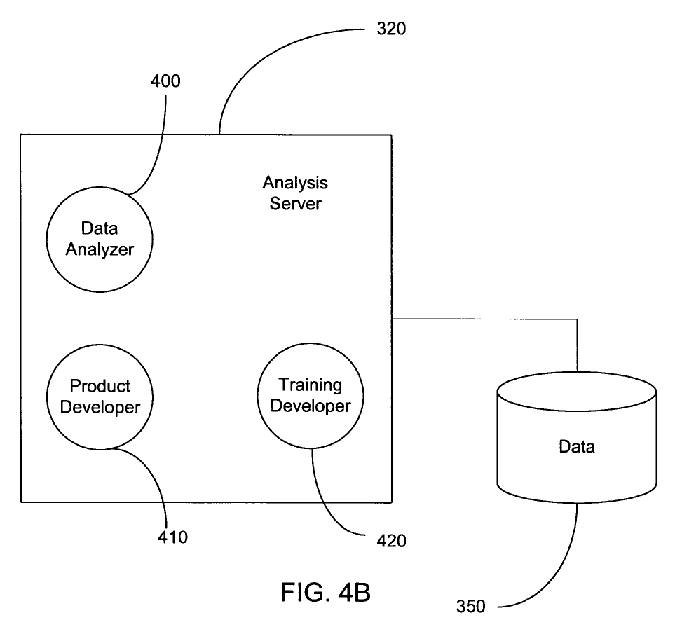

FIG. 4A is a block diagram illustrating an embodiment of a system 300 for improving sales of a company utilizing the above methods 100, 200. The system 300 may include one or more collection devices 310 (e.g., computer, laptop, palm top, PDA, internet phone, interactive form) for each mystery shopper. Each collection device 310 may have an input means for inputting the answers to the mystery shopping questions. One or more analysis servers 320 of the system 300 are communicatively coupled with the one or more collection devices 310 of the respective mystery shoppers via a communication network 330 (e.g., Internet) and communication links 340. Data such as data representative of answers to the mystery shopping questions may be transmitted from the collection devices 310 to the analysis server 320 via the communication network 330 and the communication links 340, and stored in the database 350.

With reference to FIG. 4b, the analysis server 320 may include a data analyzer 400 to analyze customer shopping data and determine a relevant improvement factor; a product developer 410 to develop or identify a knowledge product related to the relevant improvement factor; and a training developer 420 to develop or identify a training program related to the relevant improvement factor and the knowledge product 160. In an alternative embodiment, one or more of the data analyzer 400, the product developer 410, and the training developer 420 may be located on the server 320 and/or different servers. In a further embodiment, one or more of the data analyzer 400, the product developer 410, and the training developer 420 may be individuals (as opposed to a computer) that perform these tasks.

The collection device 310 receives shopping data via the input means and provides the data to the server 320 via the communication network 330 and communication links 340, and the data analyzer 400 analyzes the data and data is stored in database 350. A relevant improvement factor is determined by the data analyzer 400, and a knowledge product 160 specific to improving that improvement product is created or identified by the product developer 410 and/or a training program specific to improving that improvement product is created or identified by the training developer 420. The knowledge product 160 and/or training then may be implemented in step 150 as described above with respect to methods 100, 200.

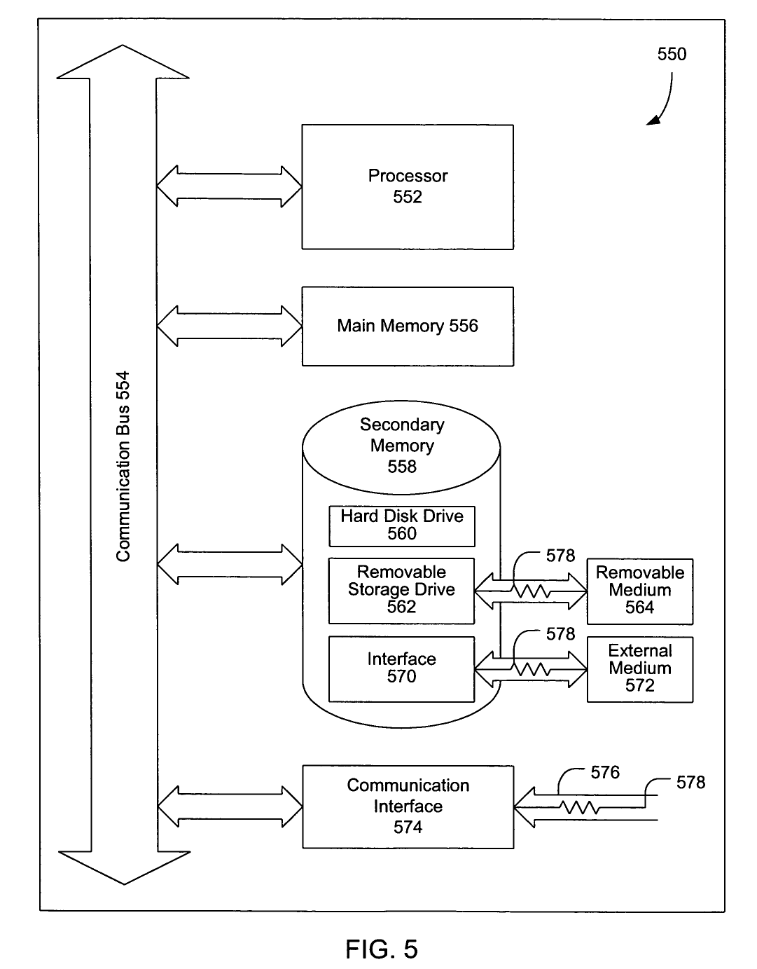

FIG. 5 is a block diagram illustrating an exemplary computer system 550 that may be used in connection with the various embodiments described herein. For example, the computer system 550 may be used in conjunction with collection of answers to the mystery shopping questions (i.e., the collection device 310) or may be used in conjunction with the server functions described above for the analysis server 320. However, other computer systems and/or architectures may be used, as will be clear to those skilled in the art.

The computer system 550 preferably includes one or more processors, such as processor 552. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 552.

The processor 552 is preferably connected to a communication bus 554. The communication bus 554 may include a data channel for facilitating information transfer between storage and other peripheral components of the computer system 550. The communication bus 554 further may provide a set of signals used for communication with the processor 552, including a data bus, address bus, and control bus (not shown). The communication bus 554 may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or standards promulgated by the Institute of Electrical and Electronics Engineers (“IEEE”) including IEEE 488 general-purpose interface bus (“GPIB”), IEEE 696/S-100, and the like.

Computer system 550 preferably includes a main memory 556 and may also include a secondary memory 558. The main memory 556 provides storage of instructions and data for programs executing on the processor 552. The main memory 556 is typically semiconductor-based memory such as dynamic random access memory (“DRAM”) and/or static random access memory (“SRAM”). Other semiconductor-based memory types include, for example, synchronous dynamic random access memory (“SDRAM”), Rambus dynamic random access memory (“RDRAM”), ferroelectric random access memory (“FRAM”), and the like, including read only memory (“ROM”).

The secondary memory 558 may optionally include a hard disk drive 560 and/or a removable storage drive 562, for example a floppy disk drive, a magnetic tape drive, a compact disc (“CD”) drive, a digital versatile disc (“DVD”) drive, etc. The removable storage drive 562 reads from and/or writes to a removable storage medium 564 in a well-known manner. Removable storage medium 564 may be, for example, a floppy disk, magnetic tape, CD, DVD, etc.

The removable storage medium 564 is preferably a computer readable medium having stored thereon computer executable code (i.e., software) and/or data. The computer software or data stored on the removable storage medium 564 is read into the computer system 550 as electrical communication signals 578.

In alternative embodiments, secondary memory 558 may include other similar means for allowing computer programs or other data or instructions to be loaded into the computer system 550. Such means may include, for example, an external storage medium 572 and an interface 570. Examples of external storage medium 572 may include an external hard disk drive or an external optical drive, or and external magneto-optical drive.

Other examples of secondary memory 558 may include semiconductor-based memory such as programmable read-only memory (“PROM”), erasable programmable read-only memory (“EPROM”), electrically erasable read-only memory (“EEPROM”), or flash memory (block oriented memory similar to EEPROM). Also included are any other removable storage units 572 and interfaces 570, which allow software and data to be transferred from the removable storage unit 572 to the computer system 550.

Computer system 550 may also include a communication interface 574. The communication interface 574 allows software and data to be transferred between computer system 550 and external devices (e.g. printers), networks, or information sources. For example, computer software or executable code may be transferred to computer system 550 from a network server via communication interface 574. Examples of communication interface 574 include a modem, a network interface card (“NIC”), a communications port, a PCMCIA slot and card, an infrared interface, and an IEEE 1394 fire-wire, just to name a few.

Communication interface 574 preferably implements industry promulgated protocol standards, such as Ethernet IEEE 802 standards, Fiber Channel, digital subscriber line (“DSL”), asynchronous digital subscriber line (“ADSL”), frame relay, asynchronous transfer mode (“ATM”), integrated digital services network (“ISDN”), personal communications services (“PCS”), transmission control protocol/Internet protocol (“TCP/IP”), serial line Internet protocol/point to point protocol (“SLIP/PPP”), and so on, but may also implement customized or non-standard interface protocols as well.

Software and data transferred via communication interface 574 are generally in he form of electrical communication signals 578. These signals 578 are preferably provided to communication interface 574 via a communication channel 576. Communication channel 576 carries signals 578 and can be implemented using a variety of communication means including wire or cable, fiber optics, conventional phone line, cellular phone link, radio frequency (RF) link, or infrared link, just to name a few.

Computer executable code (i.e., computer programs or software) is stored in the main memory 556 and/or the secondary memory 558. Computer programs can also be received via communication interface 574 and stored in the main memory 556 and/or the secondary memory 558. Such computer programs, when executed, enable the computer system 550 to perform the various functions of the present invention as previously described.

In this description, the term “computer readable medium” is used to refer to any media used to provide computer executable code (e.g., software and computer programs) to the computer system 550. Examples of these media include main memory 556, secondary memory 558 (including hard disk drive 560, removable storage medium 564, and external storage medium 572), and any peripheral device communicatively coupled with communication interface 574 (including a network information server or other network device). These computer readable mediums are means for providing executable code, programming instructions, and software to the computer system 550.

In an embodiment that is implemented using software, the software may be stored on a computer readable medium and loaded into computer system 550 by way of removable storage drive 562, interface 570, or communication interface 574. In such an embodiment, the software is loaded into the computer system 550 in the form of electrical communication signals 578. The software, when executed by the processor 552, preferably causes the processor 552 to perform the inventive features and functions previously described herein.

Various embodiments may also be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

In summary, the above method 100 evaluates a company's selling process via a mystery shopping step, determines the relevant factors where the company needs improving based on a mystery shopping step, develops a unique knowledge product and/or training to improve the factor of the company's that needs improvement, and implements with the company the knowledge product and/or training to improve the company's selling process and increase sales for the company. Because the above method 100 uses a targeted approach, namely, determining a specific factor or area where employees or service need improvement, and targeting the factor with a specific knowledge product and/or training geared to improve that factor, improvement in employee performance and service is immediately identifiable. The training has long-lasting results because it is focused on improvement of the improvement factor and ties in the knowledge product 160, which is kept by the employee. The training is reinforced every time the employee senses the knowledge product 160. Accordingly, improved employee performance and service is sustained over long periods of time. Improvement in employee performance and services improves guest satisfaction, resulting in increased sales.

It will be readily apparent to those skilled in the art that still further changes and modifications in the actual concepts described herein can readily be made without departing from the spirit and scope of the invention as defined by the following claims.

1. A method for improving sales of a company, comprising:
performing mystery shopping at a company;
evaluating the mystery shopping;
transmitting evaluation data for the mystery shopping to a central location;
determining a relevant improvement factor for the company at the central location based on analysis of the evaluation data for the mystery shopping;
developing a specific knowledge product for improving employees of the company in the relevant improvement factor;
implementing the specific knowledge product with the employees of the company for improving the employees of the company in the relevant improvement factor, increasing customer satisfaction and sales.

2. The method of claim 1, wherein an entity receives consideration from the company for providing the method to the company, and at least a portion of the consideration is returned to the company if providing the method does not improve sales.

3. The method of claim 1, wherein at least one of the above method and one or more steps of the above method are performed multiple times with employees of the same company to improve multiple improvement factors.

4. The method of claim 1, wherein performing mystery shopping at a company includes performing mystery shopping at multiple store locations of a company.

5. The method of claim 1, wherein performing mystery shopping at a company includes mystery shopping multiple times at a store location of a company.

6. The method of claim 1, wherein evaluating the mystery shopping includes answering a number of predetermined questions related to the mystery shopping immediately after performing the mystery shopping.

7. The method of claim 1, wherein transmitting evaluation data for the mystery shopping to a central location includes accessing a web site and providing answers to a number of predetermined questions related to the mystery shopping to the central location via the web site.

8. The method of claim 1, wherein transmitting evaluation data for the mystery shopping to a central location includes transmitting answers to a number of predetermined questions related to the mystery shopping to the central location wirelessly using a wireless communication device.

9. The method of claim 1, further including developing a specific training program for improving employees of the company in the relevant improvement factor; and implementing with the specific knowledge product the specific training program with the employees of the company for improving the employees of the company in the relevant improvement factor, increasing customer satisfaction and sales.

10. The method of claim 1, wherein determining a relevant improvement factor for the company at the central location based on analysis of the evaluation data for the mystery shopping includes determining multiple relevant improvement factors for the company at the central location based on analysis of the evaluation data for the mystery shopping, developing a specific knowledge product and a specific training program for improving employees of the company in the relevant improvement factor includes developing multiple respective specific knowledge products and specific training programs for the multiple respective relevant improvement factors; and implementing the specific knowledge product and the specific training program with the employees of the company for improving the employees of the company in the relevant improvement factor includes implementing the multiple respective specific knowledge products and specific training programs with the employees of the company for improving the employees of the company in the multiple respective relevant improvement factors.

11. The method of claim 1, wherein the specific knowledge product is a concrete, tangible, physical product capable of being sensed by at least two of the five basic human senses.

12. The method of claim 1, wherein the specific knowledge product is a concrete, tangible, physical product capable of being sensed by at least three of the five basic human senses.

13. A method for improving service of an service entity, comprising:
performing mystery evaluation at a service entity location;
transmitting evaluation data for the mystery evaluation to a central location;
determining a relevant improvement factor for the service entity at the central location based on analysis of the evaluation data for the mystery evaluation;
developing a specific knowledge product for improving members of the service entity in the relevant improvement factor;
implementing the specific knowledge product with the members of the service entity for improving the members of the service entity in the relevant improvement actor, improving service.

14. The method of claim 13, wherein the service entity is an entity from the group consisting of a commercial entity, a public sector entity, a non-profit entity, a charitable entity, a volunteer entity, and a religious entity.

15. The method of claim 13, wherein the specific knowledge product is a concrete, tangible, physical product capable of being sensed by at least two of the five basic human senses.

16. The method of claim 13, wherein the specific knowledge product is a concrete, tangible, physical product capable of being sensed by at least three of the five basic human senses.

17. The method of claim 13, further including developing a specific training program for improving members of the service entity in the relevant improvement factor; and implementing with the specific knowledge product the specific training program with the members of the service entity for improving members of the service entity in the relevant improvement factor, improving service.

18. A method for improving sales of a company, comprising:
determining a relevant improvement factor for employees of the company at a central location based on analysis of customer shopping data;
developing a specific knowledge product and a specific training program for improving employees of the company in the relevant improvement factor;
implementing the specific knowledge product and the specific training program with the employees of the company for improving the employees of the company in the relevant improvement factor, increasing customer satisfaction and sales.

19. The method of claim 18, wherein the specific knowledge product is a concrete, tangible, physical product capable of being sensed by at least two of the five basic human senses.

20. The method of claim 18, wherein the specific knowledge product is a concrete, tangible, physical product capable of being sensed by at least three of the five basic human senses.

21. A system for improving sales of a company, comprising:
a collection device having an input means;
an analysis server, communicatively coupled with the collection device via a communication network and including a data analyzer configured to analyze customer shopping data and determine a relevant improvement factor;
a product developer configured to develop a knowledge product related to the relevant improvement factor; and
a training developer configured to develop a training program related to the relevant improvement factor and the knowledge product;
wherein the collection device receives shopping data via the input means and provides the data to the server via the communication network and the data analyzer of the server analyzes the data and determines an improvement factor, and a knowledge product related to the improvement factor is created by the product developer and a training program related to the improvement factor is created by the training developer.
